(19) United States
(12) Patent Application Publication
(10) Pub. No.: US 2026/0320591 A1
(43) Pub. Date: Oct. 15, 2026

(54) ENHANCED SECURITY CREDIT CARDS

(71) Applicant: Bank of America Corporation, Charlotte, NC (US)

(72) Inventors: Maharaj Mukherjee, Poughkeepsie, NY (US); George Albero, Charlotte, NC (US)

(21) Appl. No.: 19/178,801

(22) Filed: Apr. 14, 2025

(51) Int. Cl. G06Q 20/38; G06Q 20/32; G06Q 20/40; G07F 7/08

(52) U.S. Cl. CPC G06Q 20/3821; G06Q 20/3229; G06Q 20/3276; G06Q 20/40145; G07F 7/0846

(57) ABSTRACT

Apparatus and methods for enhanced security cards are provided. The enhanced security card may include non-visible card data. The enhanced security card may include a QR code. When the enhanced security card is placed near a mobile device belonging to the cardholder, an application on the mobile device may activate. The cardholder may be authenticated. The application may generate a random security code. The application may display the random security code and the card data on a screen. The random security code may be transmitted to a central credit card processing server.

### FIELD OF TECHNOLOGY

Aspects of the disclosure relate to credit cards. Specifically, aspects of the disclosure relate to apparatus and methods for enhanced security for credit cards.

### BACKGROUND OF THE DISCLOSURE

Credit (and debit) cards are among the most widely used payment forms in use today. It is anticipated that they will continue to be widely used for payment for the foreseeable future.

Credit cards currently have a variety of features, including sixteen (or more) digits for the credit card number, one or more card security codes, expiration dates, cardholder names, EMV chips, magnetic data strips, and other features. Many of these features provide security and are printed or included with a credit card.

One vulnerability for credit cards may be the physical printing of credit card data such as the credit card number, expiration date, cardholder name, and card security codes. If the physical card is lost or stolen, a malicious actor may have most or all of the information necessary to use the credit card online or elsewhere.

Removing (i.e., not printing) this data on the physical card may reduce or eliminate this vulnerability. However, removing the card data may reduce the functionality of using the card by the cardholder or other authorized user.

Therefore, it would be desirable to reduce or eliminate this vulnerability while also maintaining functionality for an authorized user. This disclosure provides apparatus and methods for enhanced security credit cards.

### SUMMARY OF THE DISCLOSURE

It is an object of this disclosure to provide apparatus and methods for enhanced security credit cards.

An enhanced security credit card is provided. The enhanced security credit card may have a thickness not greater than 0.8 millimeters (“mm”) and a surface area not greater than 86 mm×54 mm.

The enhanced security credit card may include an EMV chip, a front surface, a back surface, and a wireless communication interface configured to provide wireless communication, among other components.

When the enhanced security credit card is within a pre-determined proximity of a mobile device, the enhanced security credit card may be configured to communicate over the wireless communication interface with the mobile device. The communication may include a command to automatically launch an application on the mobile device.

The application may be configured to authenticate a user of the credit card. The application may be configured to automatically generate a random security code. The application may be configured to display the random security code on a screen of the mobile device. The application may be configured to display a sixteen-digit (or other digit) credit card number corresponding to card payment data on the screen of the mobile device. The application may be configured to transmit the random security code and the sixteen-digit credit card number to a credit card payment processing service.

In an embodiment, the enhanced security credit card may further include an embedded subscriber identification module (“E-SIM”).

In an embodiment, the E-SIM may store the sixteen-digit card number, a name of the user associated with the enhanced security credit card, a date of expiration for the card number, a maximum spending limit value associated with the card number, and a telephone number associated with the card number.

In an embodiment, the front surface may have no alphanumeric indicia identifying card payment data such as the card number, the security code, a date of expiration, and a name of the user, or other card data.

In an embodiment, the back surface may have no alphanumeric indicia identifying card payment data such as the card number, the security code, a date of expiration, and a name of the user, or other card data.

In an embodiment, the card payment data may be embedded in a QR code shown on either the front surface or the back surface. The QR code may be configured to be scanned by the mobile device.

In an embodiment, the pre-determined proximity may be a proximity that enables a radio frequency identification (“RFID”) communication between the enhanced security credit card and the mobile device.

In an embodiment, the enhanced security credit card may include a power source.

In an embodiment, the power source may be rechargeable.

In an embodiment, the enhanced security credit card may include non-transitory memory.

In an embodiment, the authentication process may include use of one or more biometric authenticators.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative enhanced security credit card in accordance with principles of the disclosure.

FIG. 4 shows an illustrative prior art credit card in accordance with principles of the disclosure.

FIG. 5 shows an illustrative flowchart in accordance with principles of the disclosure.

FIG. 6 shows an illustrative schematic in accordance with principles of the disclosure.

### DETAILED DESCRIPTION OF THE DISCLOSURE

An enhanced security credit card is provided. For the purposes of the disclosure, an enhanced security credit card and/or an enhanced security debit card may be understood to refer to any debit or credit card that generally shares the dimensions of a typical debit or credit card and may, in certain circumstances and configurations, be used to perform transactions. The enhanced security credit card may include wireless communication capabilities. The enhanced security credit card may be in wireless communication with a digital wallet (or other) application. The digital wallet application may be resident on a user's mobile device.

An enhanced security credit card is provided. The enhanced security credit card may have a thickness not greater than 0.8 millimeters (“mm”) and a surface area not greater than 86 mm×54 mm. This may be considered the standard or typical credit card size.

The enhanced security credit card may include an EMV chip, a front surface, a back surface, and a wireless communication interface configured to provide wireless communication, among other components. The EMV chip is an Europay, Mastercard, and Visa chip standard. An EMV chip may store a credit card number and other data to allow for credit card transactions at a point-of-sale (“POS”) terminal equipped with an EMV chip reader.

The enhanced security credit card may include a communication interface. The communication interface may have a thickness that is not greater than 0.8 mm. The communication interface may include circuity for establishing electronic communication with a device. The communication interface may be configured to implement protocols for wireless communication. The communication interface may include one or more antennae for transmitting and receiving wireless signals. The communication interface may use RFID technology, NFC technology, or other wireless communication technologies.

The communication interface may include communication circuitry. The communication circuitry may include software and/or hardware for establishing a wired or wireless communication channel with the device. The communication interface may be compatible with illustrative wireless channels such as Wi-Fi, RFID, Bluetooth, Ethernet, NFC, satellite and cellular telecommunications. Wi-Fi may include passive Wi-Fi with lower power consumption than typical Wi-Fi. The communication interface may include a Near Field Communication (“NFC”) chip. The NFC chip may communicate over a typical NFC range (~2 in.) when transmitting or receiving sensitive data. An illustrative NFC chip may utilize a 13.56 MHz radio frequency.

When the enhanced security credit card is within a pre-determined proximity of a mobile device, the enhanced security credit card may be configured to communicate over the wireless communication interface with the mobile device. The communication may include a command to automatically launch an application on the mobile device. In some situations the power for the communication may be provided by the enhanced security card (via a battery or otherwise). In other embodiments, the power may be transmitted wirelessly from the mobile device to the enhanced security card. For example, when the enhanced security card is within a pre-determined distance from the mobile device, the mobile device may provide power wirelessly to the enhanced security card. Beyond that pre-determined distance, no power may be provided, and the enhanced security card will not communicate with the mobile device. Wireless power may provide an extra level of security.

The application may be configured to authenticate a user of the credit card. Any suitable authentication method or methods may be used.

The application may be configured to automatically generate a random security code. In a standard credit card, the security code is static and printed on the face (or back) of the credit card, where a malicious actor can see the code.

The application may be configured to display the random security code on a screen of the mobile device. The application may be configured to display a sixteen-digit credit card number corresponding to card payment data on the screen of the mobile device. Displaying the code and credit card number, along with other card data may allow an authorized user to use the credit card data for an online or telephonic transaction.

The application may be configured to transmit the random security code and the sixteen-digit credit card number to a credit card payment processing service. Every credit card is linked to an existing credit card payment processing service, such as Visa or Mastercard. When the application generates a new random security code, that code must be transmitted to the processing service to link the code to the correct card in order that a transaction may be completed.

In an embodiment, the transmission may be encrypted. Any suitable encryption method may be used.

In an embodiment, the enhanced security credit card may further include an embedded subscriber identification module (“E-SIM”). An E-SIM may provide further functionality beyond the EMV chip or magnetic data strip.

In an embodiment, the E-SIM may store the sixteen-digit card number, a name of the user associated with the enhanced security credit card, a date of expiration for the card number, a maximum spending limit value associated with the card number, and a telephone number associated with the card number, among other data.

In an embodiment, the front surface may have no alphanumeric indicia identifying card payment data such as the card number, the security code, a date of expiration, and a name of the user, or other card data. This lack of printed alphanumeric data may provide further security in the event the card is lost, stolen, or misplaced.

In an embodiment, the back surface may have no alphanumeric indicia identifying card payment data such as the card number, the security code, a date of expiration, and a name of the user, or other card data. This lack of printed alphanumeric data may provide further security in the event the card is lost, stolen, or misplaced.

In an embodiment, the card payment data may be embedded in a QR code shown on either the front surface or the back surface. The QR code may be configured to be scanned by the mobile device.

In an embodiment, a QR code may provide instructions to a mobile device (e.g., to open a particular application or website) instead of providing the actual card payment data.

In an embodiment, the pre-determined proximity may be a proximity that enables a near-field communication (“NFC”) between the enhanced security credit card and the mobile device. This proximity may be determined by the hardware available to the mobile device. The proximity distance may be static. The proximity distance may be variable. The proximity distance may be varied automatically by the application.

In an embodiment, the enhanced security credit card may include a power source. The power source may be a battery. In an embodiment, the power source may be external, e.g., as in wireless charging capability.

In an embodiment, the power source may be rechargeable.

In an embodiment, the enhanced security credit card may include non-transitory memory. The non-transitory memory may store the same or additional data in addition to the data stored in an EMV chip and the magnetic data stripe. The data may be encrypted.

In an embodiment, the enhanced security credit card may include one or more microprocessors. The microprocessors may be used to perform various functions, including transmitting data or instructions.

In an embodiment, the authentication process may include use of one or more biometric authenticators. Biometric authenticators may be more secure than a standard authentication method.

An enhanced security credit card system is provided. The enhanced security credit card system may include a plurality of enhanced security credit cards and a digital wallet application resident on a mobile device of each cardholder.

Each of the plurality of enhanced security credit cards may have a thickness not greater than 0.8 millimeters (“mm”) and a surface area not greater than 86 mm×54 mm. Each enhanced security. Each enhanced security credit card may include a power supply, a proximity sensor, a wireless communication interface configured to provide wireless communication, an EMV chip, a QR code, and non-transitory memory configured for storing card data.

The card data may include a card number, a date of expiration for the card number, a static card security code, and a cardholder name, among other data. The data may be encrypted.

When the proximity Sensor senses that the enhanced security credit card is within a pre-determined distance from the mobile device, signal may be transmitted from the wireless communication interface to the mobile device instructing the mobile device to open the digital wallet application, Any suitable proximity sensor or method may be used. For example, the card may send out a signal periodically that may only be answered when within a certain distance of a mobile device that includes the application.

The digital wallet application may be configured to: authenticate the cardholder, automatically generate a random. security code, display the random security code on the mobile device, and display the card data on the mobile device.

In an embodiment, the card number may be a static card number.

In an embodiment, some of or all of the card data may be dynamic card data. Dynamic card data is data that may change based on various conditions. For example, a new credit card number may be generated for every proposed transaction. Or there may be a finite list of valid credit card numbers (e.g., five or ten) and the number to be used for every transaction may be randomly selected from the list.

In an embodiment, the pre-determined distance may be less than one foot.

In an embodiment, the random security code may be generated based on an amount of a transaction. For example, a smaller transaction may generate a shorter random security code (e.g., four digits).

A larger transaction may generate a longer random security code (e.g., six or ten digits).

The threshold between smaller and larger transactions (e.g., $500) may be set by the cardholder, a financial institution, and/or the digital wallet application. The threshold may be static or dynamic. The threshold may be automatically adjusted after an analysis by an artificial intelligence/machine learning (“AI/ML”) algorithm. Any appropriate AI/ML algorithm or algorithms may be used.

In an embodiment, the random security code may be generated based on an identity of a merchant. For example, more secure or more trustworthy merchants may lead to a shorter random security code. Less secure or trustworthy merchants may generate a longer random security code.

In an embodiment, the random security code may be generated based on a location of the merchant. For example, even a generally secure or trustworthy merchant may have a particular location or franchise that may be considered less secure or trustworthy. In that situation, a longer random security code may be generated. Alternatively, all merchants in a particular geographic area or location may require a shorter or longer random security code.

In an embodiment, the data on the non-transitory memory may be re-writable by the digital wallet application.

In an embodiment, each enhanced security card may have no card data printed on it. In an embodiment, the card data may only be fully or partially embedded within a machine-readable (but not human readable) QR code printed on the enhanced security card.

A method for enhancing security of a credit card with a thickness not greater than 0.8 millimeters (“mm”) and a surface area not greater than 86 mm×54 mm is provided.

The method may include the step of storing card data in a database associated with a digital wallet application on a mobile device belonging to a user.

The method may include the step of printing a QR code on the credit card, and no other card data on the credit card.

The method may include the step of pointing a camera on the mobile device at the QR code.

The method may include, in response to pointing the camera at the QR code, the step of opening the digital wallet application.

The method may include the step of authenticating the user.

The method may include the step of automatically generating a random security code.

The method may include the step of displaying the random security code and the card data on a screen on the mobile device.

When prompted by the user, the method may include the step of transmitting the random security code and the card data to a credit card payment processing service.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

Non-transitory memory may be configured to store executable data configured to run on a processor or read by a separate computing device.

The microprocessors may control the operation of the computer system and its components, which may include RAM, ROM, an input/output module, and other memory.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, bluetooth, LAN, and cellular links. Multiple communication links may be present. In an embodiment, the network used to communicate may be the Internet. In another embodiment, the network may be an internal intranet or other internal network.

The enhanced security credit card may include an embedded subscriber identification module (“E-SIM”) card. The E-SIM may be configured to store card data. The card data may be re-writable card data associated with the enhanced security credit card.

An E-SIM is a very small chip that may be embedded directly into the hardware of the enhanced security credit card. An E-SIM is a global specification by the Global System for Mobile Communications Associations (“GSMA”) which may enable remote SIM provisioning (“RSP”) of any mobile device.

The traditional SIM card is inserted into mobile devices and may occupy a significant portion of the device. E-SIM's, when embedded into the hardware of mobile devices such as a smartphone, occupy a much smaller portion of the device then the traditional SIM cards. E-SIM's, in the usage with mobile devices, include information that enables a subscriber to access a mobile operator. A single user's device that includes an E-SIM may be enabled to have multiple mobile operators associated with the one mobile device for different purposes and services. For example, when travelling to a different country there may be no need to swap SIM cards. The E-SIM is configured to be accessed and updated remotely and can switch operators when in a different county. Phone numbers associated with the smartphone may be changed remotely and directly stored on the E-SIM. All data changes and configurations may be enabled via a remote SIM provisional solution (“RSP”).

An advantage of the E-SIM is that all data and information stored on the E-SIM is rewritable and therefore when a change is made in the data, the E-SIM does not need to be replaced. Because the E-SIM is embedded in the hardware of the device, the E-SIM may be tamper-proof and theft-proof.

For the purpose of the disclosure, embedding an E-SIM into the hardware of the enhanced security credit card may enable card payment data associated with the enhanced security credit card to be updated and changed remotely without the need of replacing the card. Through wireless communication capabilities and the machine-to-machine (“M2M”) communication between the enhanced security credit card and associated software applications, data changes may be directly re-written on the E-SIM and stored on the E-SIM.

The E-SIM may be an MFF 2 which may be a height of 6 mm, a width of about 5 mm and 0.67 mm in thickness. In some embodiments, the E-SIM may be 2.5 mm×2.3 mm×0.2 mm (thick).

It should be appreciated that the size of the enhanced security credit card disclosed herewith, including the E-SIM, may not disrupt the traditional form factor of the standard debit/credit card. For reference, an exemplary form factor of an enhanced security credit card according to the embodiments may be about 53.98 mm×about 85.60 mm×about 0.8 mm (thick).

In an embodiment, the enhanced security credit card may also include a microprocessor. The enhanced security credit card may include a wireless communication interface configured to provide wireless communication.

The enhanced security credit card may include various other components, such as a battery, a speaker, and antennas. The microprocessor may have a thickness that is not greater than. 25 millimeters (“mm”). The microprocessor may control overall operation of the enhanced security credit card and its associated components. The enhanced security credit card may include RAM, ROM, an input/output (“I/O”) module and a non-transitory or nonvolatile memory.

The I/O module may include a microphone which may accept user provided input. The I/O module may include one or more speaker(s) for providing audio output and a touch screen for providing textual, audiovisual and/or graphical output. Software may be stored within the non-transitory memory and/or other storage media. The software may provide instructions to the microprocessor for enabling the enhanced security credit card to perform various functions. For example, the non-transitory memory may store software used by the enhanced security credit card, such as an operating system and application programs.

Alternatively, some or all of computer executable instructions of the enhanced security credit card may be embodied in hardware or firmware components of the enhanced security credit card. Application programs, which may be used by the enhanced security credit card, may include computer executable instructions for invoking user functionality related to communication, authentication services, and voice input and speech recognition applications. Application programs may utilize one or more algorithms that encrypt information, process received executable instructions, interact with a POS terminal and perform power management routines or other suitable tasks. The enhanced security credit card may include non-transitory memory locations within the housing. The microprocessor may access such memory locations. The non-transitory memory locations may be included in the microprocessor. The non-transitory memory locations may store software, that when executed by the microprocessor, cause the enhanced security credit card to perform various functions.

In some embodiments, the enhanced security credit card may be activated in response to receiving high frequency wireless signals. The high frequency signals may be detected by the communication interface. The high frequency signals may be generated by a mobile device or POS terminal. The mobile device or POS terminal may include an NFC reader. The NFC reader may be embedded within mobile device within the pre-determined proximity of the enhanced security credit card. The high frequency signals may provide power to one or more components of the enhanced security credit card. In some embodiments, in response to receiving the power, the microprocessor may be activated and begin to draw power from a battery on the enhanced security credit card.

The enhanced security credit card may operate in a networked environment. The enhanced security credit card may support establishing communication channels with one or more devices. The enhanced security credit card may connect to a local area network (“LAN”), a wide area network (“WAN”) or any suitable network. When used in a LAN networking environment, the enhanced security credit card may be connected to the LAN through a network interface or adapter. The communication interface may include the network interface or adapter.

When used in a wan networking environment, the enhanced security credit card may include a modem or other means for establishing communications over a WAN, such as the Internet. The communication interface may include the modem. It will be appreciated that the network connections shown are illustrative and other means of establishing a communications link between devices may be used. The existence of any of various well known protocols such as TCP/IP, Ethernet, FTP, HTTP and the like is presumed.

The enhanced security credit card may utilize computer-executable instructions, such as program modules, being executed by the microprocessor. Generally, program modules include routines, programs, objects, components, data structures, etc. that perform particular tasks or implement particular abstract data types. The enhanced security credit card may be operational with distributed computing environments where tasks are performed by remote processing devices that are linked through a communications network. In a distributed computing environment, program modules may be located in both local and remote computer storage media including memory storage devices.

The enhanced security credit card may include one or more batteries. A battery of the enhanced security credit card may be flexible. The battery may be a power source for electronic components of the enhanced security credit card. For example, the battery may supply power to the communication interface, memory, and a microprocessor if used. The battery may have a thickness that is not greater than 0.5 mm.

The battery may be recharged via an electrical contact, such as, for example, when the enhanced security credit card is in contact with a device. The enhanced security credit card's power source may include high frequency signals received from a device. The enhanced security credit card may be configured to utilize received high frequency signals to recharge the battery or provide power to other components of the enhanced security credit card. The enhanced security credit card may include an electrical contact. An electrical contact may be constructed using any suitable material that conducts or transfers electricity. The enhanced security credit card may include a plurality of electrical contacts. An electrical contact may be accessible on any suitable face of a housing of the enhanced security credit card. The contact may be accessible through a thickness of the housing. The contact may be utilized to transfer electrical charge to a rechargeable battery when the enhanced security credit card is inserted into a device card reader.

The enhanced security credit card may interact with a digital wallet application or other application on a user's mobile device. A digital wallet application may enable a user to store multiple credit/debit cards within one application.

The digital wallet application may be set up via the user's financial institution. The digital wallet app may be configured to store credit/debit card payment data for each of the user's cards. The digital wallet application may also store additional information.

Card payment data for each card may include a static card number and the expiration date associated with each card number. The card payment data may also include a static security code associated with each card number, and the cardholder's name, as well as other information. In an embodiment, the data may be dynamic.

When the enhanced security credit card is within a pre-determined proximity of a mobile device, the enhanced security credit card may be configured to communicate with the mobile device. The pre-determined proximity may be a proximity that may enable a near-field communication (“NFC”) between the enhanced security credit card and the mobile device.

The card payment data may be embedded in a quick response (“QR”) code printed on the enhanced credit card. A user may scan the QR code with a mobile device to determine the card data.

To authenticate the user/cardholder and allow for determining a random security code or displaying card data for the cardholder to user, the application on the mobile device may verify/authenticate the user using any appropriate authentication method or protocol. Methods may include username/password, PIN input, one-time password, biometric authenticators, and other authentication methods.

The communication may include a request for input of a personal identification number (“PIN”) associated with an enhanced security credit card account of the user. The digital wallet application may receive input of the PIN, by the user of the enhanced security credit card. The digital wallet application may be configured to verify that the PIN matches to the PIN stored in the profile of the user of the mobile device and the enhanced security credit card. Following authentication, the digital wallet application may display the card data, generate a random security code, and transmit the random security code to a payment processing network.

A user/cardholder may have more than one credit/debit card.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMS, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e. g., air and/or space).

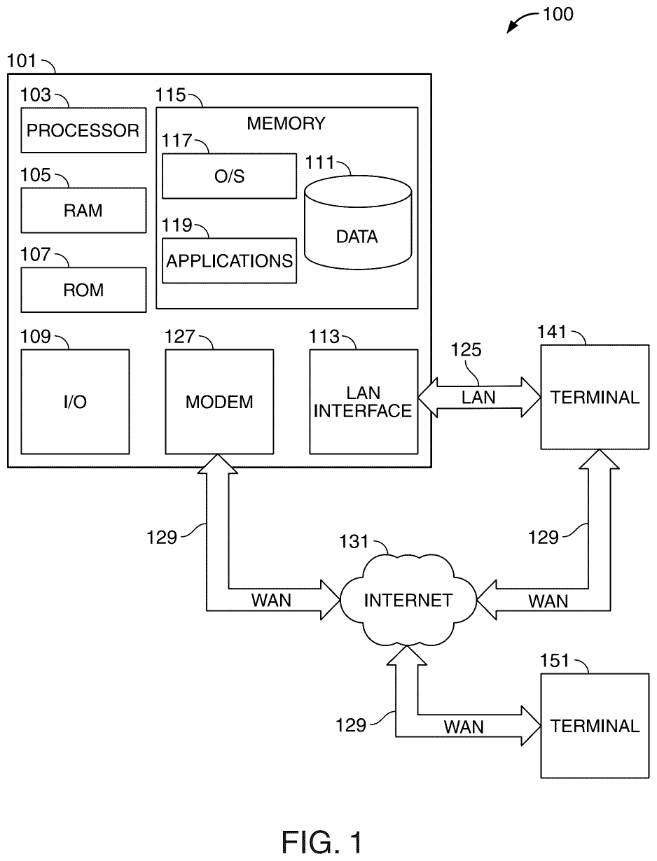

In accordance with principles of the disclosure, FIG. 1 shows an illustrative block diagram of apparatus 100 that includes a computer 101. Computer 101 may alternatively be referred to herein as a “computing device.” The computing device may be the enhanced security credit card. The computing device may be a mobile device or POS terminal. Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as a digital wallet application and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as a digital wallet application and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as a digital wallet application and security protocols) along with any data needed for the operation of the apparatus. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over RFID protocols, Bluetooth, wi-fi, cellular networks, NFC networks, or other suitable frequencies.

It will be appreciated that the network connections shown are illustrative and other means of establishing a communications link between enhanced security credit cards and mobile devices/computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for digital wallet application and security protocols, as well as other programs. In an embodiment, one or more programs, or aspects of a program, may use one or more AI/ML algorithm(s). The various tasks may be related to enhancing security for credit cards.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAS”), multiprocessor systems, microprocessor-based systems, set top boxes, programmable consumer electronics, network PCS, minicomputers, mainframe computers, distributed computing environments that include any of the above systems or devices, IOT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

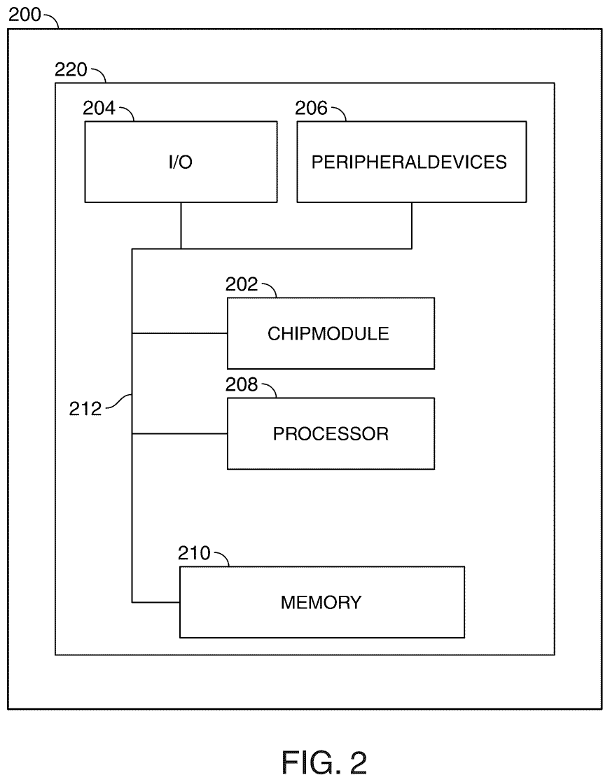

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

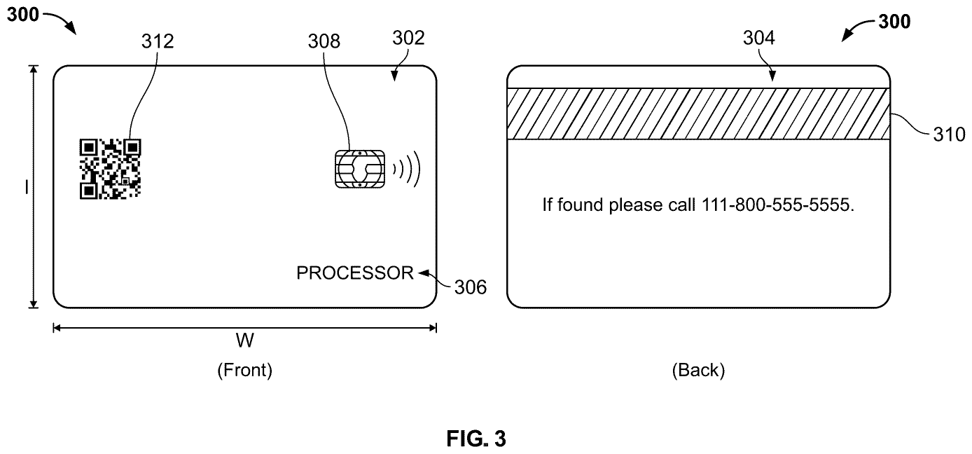

FIG. 3 shows an enhanced security credit card 300 in accordance with principles of the disclosure. Enhanced security credit card 300 may be associated with a user. Enhanced security credit card 300 may be a debit or credit card.

Enhanced security credit card 300 may have a width w and length l. Enhanced security credit card 300 may be any suitable size consistent with standard credit card sizes. For example, width w may be 53.98 millimeters (“mm”). Length l may be 85.60 mm. Enhanced security credit card 300 may have a thickness t. An illustrative thickness may be 0.8 mm. An exemplary form factor of enhanced security credit card 300 may be 53.98 mm×85.60 mm×0.8 mm. This exemplary form factor may allow enhanced security credit card 300 to fit into a user's wallet or pocket. This exemplary form factor may allow enhanced security credit card 300 to fit into a card reader of an ATM and/or any suitable POS device.

Enhanced security card may have a front surface 302 and a back surface 304. As shown, card data is not printed on either the front surface 302 or the back surface 304. Some information, such as the credit card processing service 306 and other information may be printed on the enhanced security card 300. A QR code 312 containing the card data, or other information or instructions may be printed on the enhanced security card 300.

Enhanced security card 300 may include components such as an EMV chip 308, NFC communications capability, and a magnetic data strip 310.

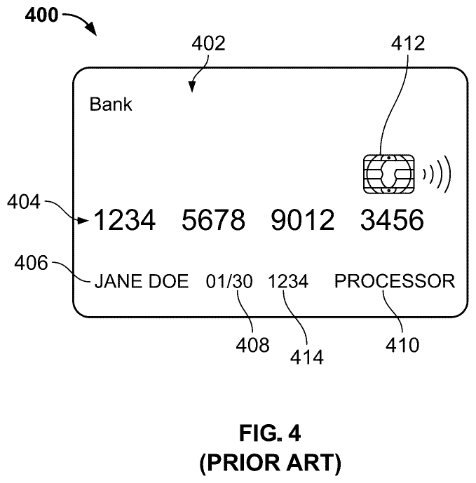

FIG. 4 shows an exemplary existing credit card (prior art). Existing credit cards may include card data printed on the card, as shown. For example, the name of the issuing financial institution 402, the card number 404, name of the cardholder 406, expiration date 408, processing service 410, card security code 414, and other data. Existing cards may include an EMV chip 412 and may communicate through NFC or other communication protocols. Some or all of the card data may be printed on the front or back of the credit card.

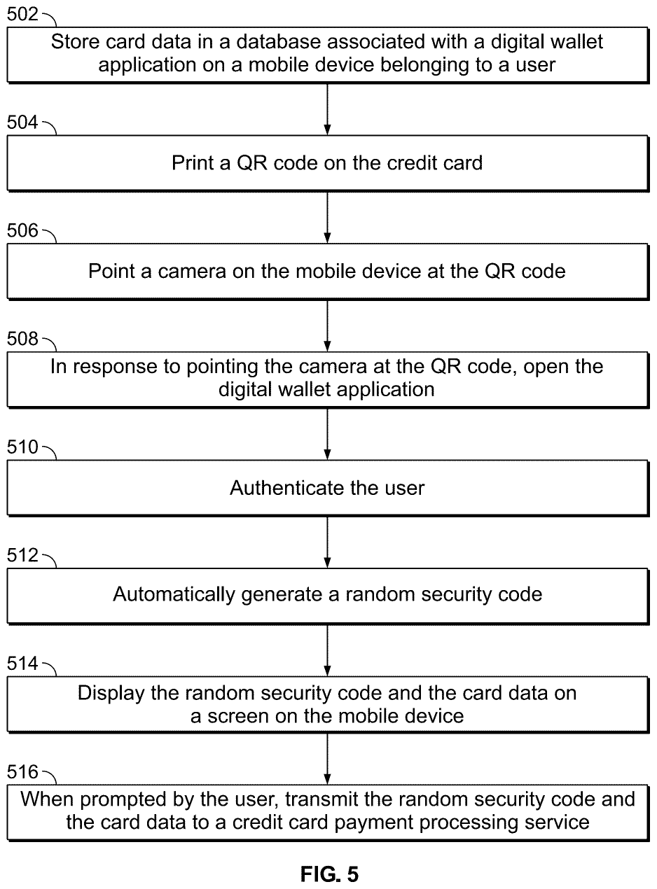

FIG. 5 shows an illustrative flowchart in accordance with principles of the disclosure. Methods may include some or all of the method steps numbered 502 through 516. Methods may include the steps illustrated in FIG. 5 in an order different from the illustrated order. The illustrative method shown in FIG. 5 may include one or more steps performed in other figures or described herein. Steps 502 through 516 may be performed on the apparatus shown in FIGS. 1-3, and 6, or other apparatus (but not the apparatus shown in FIG. 4).

At step 502, card data may be stored in a database associated with a digital wallet (or other) application on a mobile device belonging to a user. Card data may include a credit card number, card security code, expiration date, cardholder name, and other data.

At step 504, a QR code may be printed on the enhanced security credit card. The QR code may include card data and/or instructions (such as a pointer, to an application or a website).

At step 506, a user may point a camera on a mobile device at the QR code.

At step 508, in response to the user pointing the camera at the QR code, the digital wallet application (or other application) may open on the mobile device.

At step 510, the digital wallet application may authenticate the user using any appropriate authentication protocol.

At step 512, the digital wallet application may read the card data and generate a random security code.

At step 514, the digital wallet application may display the random security code and the card data on a screen of the mobile device.

At step 516, when prompted by the user, the digital wallet application may transmit the random security code and the card data to a credit card payment processing service. The data may be encrypted. Transmitting the data may be required in order to inform the credit card payment processing service of the randomly generated security code so that when the user uses the security code, it will work properly and complete the transaction.

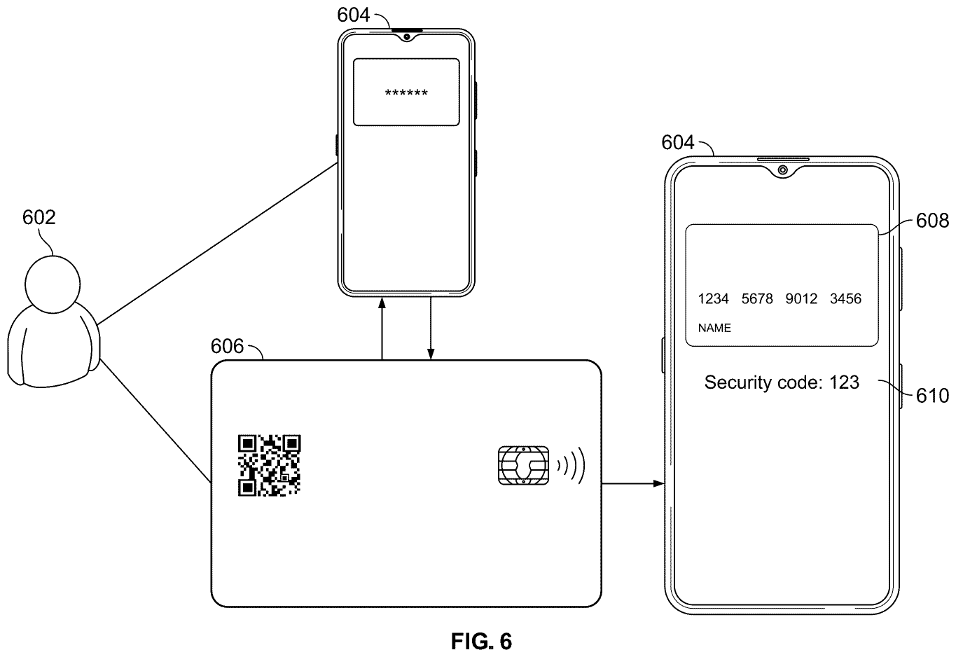

FIG. 6 shows an illustrative schematic in accordance with principles of the disclosure.

A user 602 may bring an enhanced security card 606 within a proximity of a mobile device 604.

Mobile device 604 may read data on the enhanced security card 606. This may be through a QR code printed on the card 606, through RFID signals, or other methods.

A digital wallet (or other application) on the mobile device 604 may, before authenticating the user, show no card associated with the enhanced security credit card 606.

After authenticating the user 602, the application on the mobile device 604 may display card data 608 and a randomly generated security code 610. The user 602 may then use the card data 608 and security code 610 to perform a transaction (online or otherwise).

Thus, methods and apparatus for an enhanced security credit card are provided. Persons skilled in the art will appreciate that the present invention can be practiced by other than the described embodiments, which are presented for purposes of illustration rather than of limitation, and that the present invention is limited only by the claims that follow.

1. An enhanced security credit card with a thickness not greater than 0.8 millimeters (“mm”) and a surface area not greater than 86 mm×54 mm comprising:
an EMV chip;
a front surface;
a back surface; and
a wireless communication interface configured to provide wireless communication;
wherein when the enhanced security credit card is within a pre-determined proximity of a mobile device, the enhanced security credit card is configured to:
communicate over the wireless communication interface with the mobile device; and
automatically launch an application on the mobile device; and
wherein the application is configured to:
authenticate a user;
automatically generate a random security code;
display the random security code;
display a dynamic sixteen-digit credit card number corresponding to card payment data; and
transmit the random security code and the sixteen-digit credit card number to a credit card payment processing service.

2. The enhanced security credit card of claim 1 further comprising an embedded subscriber identification module (“E-SIM”).

3. The enhanced security credit card of claim 2 wherein the E-SIM stores:
the sixteen-digit card number;
a name of the user associated with the enhanced security credit card;
a date of expiration for the card number;
a maximum spending limit value associated with the card number; and
a telephone number associated with the card number.

4. The enhanced security credit card of claim 1 wherein the front surface bears no alphanumeric indicia identifying:
the card number;
the security code;
a date of expiration; and
a name of the user.

5. The enhanced security credit card of claim 4 wherein the back surface bears no alphanumeric indicia identifying:
the card number;
the security code;
a date of expiration; and
a name of the user.

6. The enhanced security credit card of claim 1 wherein the card payment data is embedded in a QR code shown on either the front surface or the back surface and configured to be scanned by the mobile device.

7. The enhanced security credit card of claim 1 wherein the pre-determined proximity is a proximity that enables a radio frequency identification (“RFID”) communication between the enhanced security credit card and the mobile device.

8. The enhanced security credit card of claim 1 further comprising a power source.

9. The enhanced security credit card of claim 8 wherein the power source is rechargeable.

10. The enhanced security credit card of claim 1 wherein authentication includes one or more biometric authenticators.

11. An enhanced security credit card system comprising:
a plurality of enhanced security credit cards, each of the plurality of enhanced security credit cards with a thickness not greater than 0.8 millimeters (“mm”) and a surface area not greater than 86 mm×54 mm and comprising:
a power supply;
a proximity sensor;
a wireless communication interface configured to provide wireless communication;
an EMV chip;
a QR code; and
a non-transitory memory module configured for storing card data, the card data comprising:
a card number;
a date of expiration for the card number;
a static card security code; and
a cardholder name; and
a digital wallet application resident on a mobile device of the cardholder;
wherein when the proximity sensor senses that the enhanced security credit card is within a pre-determined distance from the mobile device, a signal is transmitted from the wireless communication interface to the mobile device instructing the mobile device to open the digital wallet application; and
wherein the digital wallet application is configured to:
authenticate the cardholder;
automatically generate a random security code, wherein the random security code is generated based on a location of the merchant;
display the random security code on the mobile device; and
display the card data on the mobile device.

12. The enhanced security credit card system of claim 11 wherein the card number is a static card number.

13. The enhanced security credit card system of claim 11 wherein the card data is dynamic card data.

14. The enhanced security credit card system of claim 11 wherein the pre-determined distance is less than one foot.

15. The enhanced security credit card system of claim 11 wherein the random security code is also generated based on an amount of a transaction.

16. The enhanced security credit card system of claim 11 wherein the random security code is also generated based on an identity of a merchant.

17. (canceled)

18. The enhanced security credit card system of claim 11 wherein the data on the non-transitory memory is re-writable by the digital wallet application.

19. The enhanced security credit card system of claim 11 wherein each enhanced security card has no card data printed on it.

20. A method for enhancing security of a credit card with a thickness not greater than 0.8 millimeters (“mm”) and a surface area not greater than mm×54 mm, comprising the steps of:
storing card data in a database associated with a digital wallet application on a mobile device belonging to a user;
printing one or more QR codes on the credit card;
pointing a camera on the mobile device at one of the one or more QR codes;
in response to pointing the camera at one of the one or more QR codes, opening the digital wallet application;
authenticating the user;
automatically generating a random security code;
displaying the random security code and card data on a screen on the mobile device; and
when prompted by the user, transmitting the random security code and the card data to a credit card payment processing service;
wherein the card data comprises:
a dynamic card number;
a date of expiration for the card number;
a static card security code; and
a cardholder name.
